(19) United States
(12) Patent Application Publication
(10) Pub. No.: US 2006/0142987 A1
(43) Pub. Date: Jun. 29, 2006

(54) Circuit simulation method and circuit simulation apparatus

(75) Inventors: Tomoyuki Ishizu, Nagaokakyou-shi (JP); Takuya Umeda, Kameoka-shi (JP); Katsuhiro Ootani, Kashihara-shi (JP); Yasuyuki Sahara, Kyoto-shi (JP)

Correspondence Address: MCDERMOTT WILL & EMERY LLP, 600 13TH STREET, N.W., WASHINGTON, DC, 20005-3096, US

(73) Assignee: Matsushita Electric Industrial Co., Ltd.

(21) Appl. No.: 11/313,994

(22) Filed: Dec. 22, 2005

(30) Foreign Application Priority Data
Dec. 24, 2004 (JP) P2004-374205

(51) Int. Cl. G06F 17/50

(52) U.S. Cl. 703/14; 716/19

(57) ABSTRACT

A circuit simulation apparatus and a modeling method are provided which are useful to design an integrated circuit in a very fine manner by forming a model of such a transistor that widths of element isolating-purpose insulating films are different from each other.

In an isolation width depending parameter correcting means 4 of the present invention, an approximate expression of a parameter having an element isolating-purpose insulating film width depending characteristic is formed, and a value of a corrected parameter obtained by employing the formed approximate expression is replaced by a value of an original parameter, so that a transistor model of such a transistor is formed in which element isolating-purpose insulating film widths are different from each other. As a consequence, circuit simulation can be carried out in high precision by considering a change in transistor characteristics caused by a stress, which are approximated to actually measured data.

### BACKGROUND OF THE INVENTION

1. Field of the Invention

The present invention relates to a circuit simulation method and a circuit simulation apparatus. More specifically, the present invention is directed to a modeling method of an integrated circuit, in particular, a circuit simulation apparatus which is used to design integrated circuits in high precision.

2. Description of the Related Art

Very recently, while system LSIs and the like are developed, strong demands are made of further improving simulation precision of circuit simulators. More specifically, in connection with great progress as to very fine processing techniques of semiconductors, layout patterns and arrangements of circuit elements may give large influences to performance of circuits. In particular, in transistors using such element isolation techniques as STI (Shallow Trench Isolation) and the like, a specific attention has been paid to such a fact that the below-mentioned phenomenon may constitute a factor which impede an improvement in simulation precision of circuit simulators. In this phenomenon, mobility of channels of the above-explained transistors are applied from element isolating-purpose insulating films to the transistors, so that current characteristics of the transistors are largely changed.

In a conventional technique, in order to perform circuit simulation by considering stresses which are applied from element isolating-purpose insulating films to transistors, as an index of stresses applied to the transistors, widths of the element isolating-purpose insulating films, lengths of activated regions, and the like have been defined so as to perform the circuit simulation (refer to JP-A-2004-86546).

FIG. 8 is a plan view of a transistor. In this drawing, a length of an activated region 22 functioning as an index of stresses applied to the transistor indicates a length along a vertical direction with respect to a gate 23 of a field pattern which represents a boundary among a diffusion layer, a channel forming region, and an element isolating region 25 made by the STI technique. This length of the activated region 22 corresponds to such a length 29 defined by combining a source length with a channel length. Also, a width of an element isolating-purpose insulating film indicates a distance 30 along a width direction of a channel between an edge of the activated region 22 of the transistor, and an edge of another activated region 24 located adjacent to the above-described activated region 22.

FIG. 9 is a block diagram for showing an arrangement of a conventional simulation apparatus. As indicated in this drawing, both a net list which is extracted from mask layout data 101, and a parameter which is extracted from device character data 104 corresponding to an actual measurement value of a device characteristic are entered to a circuit simulation executing means 100.

Concretely speaking, firstly, transistor size data 103a is extracted from the mask layout data 101 having design information as to a circuit to be analyzed by a shape recognizing means 102 of a transistor, and then, this transistor data 103a is entered as a net list 103 to the circuit simulation means 100 which is represented as SPICE. It should be understood that this transistor shape recognizing means 102 also recognizes a width of an element isolating-purpose insulating film and a length of an activated region.

On the other hand, data as to a parameter 107 are conducted from actually measured values of an actually measuring-purpose device, which constitutes device characteristic data 104. As to the device characteristic data 104, in the case of a transistor, a size is defined by a gate length “L” and a width “W” of a channel, and then, electric characteristics of actually measuring-purpose transistors whose sizes are different from each other are measured. Also, as to elements related to stresses such as widths of element isolating-purpose insulating films and lengths of activated regions, these elements are measured while conditions are changed.

Next, a shape recognition is carried out from the device characteristic data 104 by employing a transistor shape recognizing means 105 so as to recognize a width of an element isolating-purpose insulating film and a length of an activated region as to an actually measured transistor.

Next, based upon both the width of he element isolating-purpose insulating film and the length of the activated region which have been extracted by the transistor shape recognizing means 105 and which constitute an index of stresses applied to the transistor, a plurality of parameter extracting operations 106 are carried out with respect to such a transistor having the same gate length “L” and the same channel width “W.” FIG. 9 indicates such an example that with respect to 3 sorts of transistors which receive different stresses from each other, parameter extracting operations 106a, 106b, and 106c are carried out based upon the parameters of the stresses. It should be understood that at this stage of the parameter extracting operation 106, such an operation for replacing the acquired device characteristic data 104 by a parameter 107 having model parameter groups 107a, 107b, and 107c in response to the stresses.

Next, a reference table 109 is formed, while the reference table 109 contains information which causes transistors contained in an integrated circuit to correspond to parameters which should be applied to these transistors based upon the item which constitutes the index of the stresses applied to the transistors. An optimum parameter 107A corresponding to the transistor size data 103a is selected based upon the information of this reference table 109, and the selected optimum parameter 107A is inputted to the circuit simulation means 100, so that a circuit operation is simulated.

As a result, such an output result 108 of circuit simulation may be obtained to which an influence has been reflected with respect to the items of the stresses such as the widths of the element isolating-purpose insulating film and the lengths of the activated regions of the transistors.

In the above-described circuit simulation method, for instance, parameters have been previously extracted with respect to each of the transistors where the widths of the element isolating-purpose insulating films are different from each other so as to form the plurality of transistor models, and both the widths of the element isolating-purpose insulating films and the parameters corresponding thereto have been stored as the reference table. Then, the proper transistor model is selected from these plural transistor models based upon the information stored in the reference table in order to improve the precision of the circuit simulation. However, a lengthy time is required even when the reference table itself is formed, and further, very cumbersome processing steps are required, namely, when the optimum transistor model is selected from the plural transistor models, the transistor size data extracted from the circuit layout data to be simulated must be compared with the information stored in the reference table, so that mistakes caused by man may be easily made. Under such a circumstance, a total number as to the plural transistor models where the widths of the element isolating-purpose insulating films are different from each other, which have been previously prepared, may be suppressed to a realistic level.

FIG. 10 is a graphic representation for representing a depending characteristic of a drain current of a P channel transistor with respect to a width of an element isolating-purpose insulating film. A black circle indicates a measured value of the drain current, and a solid line represents a drain current simulated by the above-described circuit simulation method. As apparent from the graphic representation, in connection with the decrease of the width of the element isolating-purpose insulating film, the actually measured value of the drain current is continuously decreased, whereas the simulating result becomes very discrete. As a result, there is a risk that the simulating precision is lowered. Even in the conventional circuit simulation method, since a total number of the transistor models where the widths of the element isolating-purpose insulating films are made different from each other is increased, an improvement in the simulating precision may be practically expected. However, the resulting circuit simulating method may be cumbersome, for instance, necessities of increasing a total condition number as to the element isolating-purpose insulating film widths of the measuring-purpose devices must be increased; a cumbersome operation is necessarily required so as to recognize the shapes of the transistors; and a cumbersome operation is necessarily required in order to select the proper transistor model. As a consequence, there is a limitation in the total quantity of the transistor models.

### SUMMARY OF THE INVENTION

The present invention has an object to provide a method capable of forming a transistor model in high precision with respect to widths of element isolating-purpose insulating films over a wide range by using a continuous mathematical model based upon such a transistor model having a parameter which has been fitted by a predetermined element isolating-purpose isolating film width.

A circuit simulation method of the present invention is featured by a modeling method for modeling an integrated circuit which contains at least one transistor. The circuit simulation method is comprised of: a step for acquiring size data as to an element isolating-purpose insulating film width of the transistor contained in the integrated circuit; a step for defining an isolation width parameter expressed by a formula of the element isolating-purpose insulating film width, and for forming an approximate expression as to an isolation width depending parameter whose value is changed, depending upon the isolation width parameter with respect to a transistor model formed based upon a transistor having a predetermined isolation width parameter; a step for calculating a correction value of the isolation width depending parameter as to a transistor model whose isolation width parameter is different from that of the transistor model based upon the approximate expression; a step for replacing a transistor model formed based upon the transistor having the predetermined isolation width parameter by a transistor model formed based upon the isolation width depending parameter corrected by the approximate expression; and since the transistor model based upon the corrected isolation width depending parameter is employed, the circuit simulation can be performed while considering an element isolating-purpose insulating film width depending characteristic.

Also, a circuit simulation apparatus, according to the present invention, is featured by comprising: means for acquiring a shape of a transistor and size data of an element isolating-purpose insulating film width contained in an integrated circuit from layout data of the integrated circuit; means for defining an isolation width parameter “Yeff” expressed by a formula of the element isolating-purpose-insulating film width, and for forming an approximate expression as to an isolation width depending parameter whose value is changed, depending upon the isolation width parameter with respect to a transistor model formed based upon a transistor having a predetermined isolation width parameter; means for calculating a correcting value of an isolation width depending parameter as to a transistor model whose isolation width parameter is different from that of the transistor model based upon the approximate expression; means for replacing a transistor model formed based upon the transistor having the predetermined isolation width parameter by a transistor model formed based upon the isolation width depending parameter corrected by the approximate expression; and simulation executing means for reading a circuit connection description of the integrated circuit, for inputting a transistor model based upon the corrected isolation width depending parameter, and for calculating a characteristic of the transistor in which the element isolating-purpose insulating films are different from each other, while considering an element isolating-purpose insulating film depending characteristic.

In the circuit simulation method and circuit simulation apparatus of the present invention, the isolation width depending parameter contains either a carrier mobility parameter or a threshold voltage parameter, so that a correction value of a parameter can be obtained by considering an element isolating-purpose insulating film width depending characteristic.

In the circuit simulation method and circuit simulation apparatus of the present invention, the approximate expression as to the isolation width depending parameter is arranged by containing a polynomial of an inverse number of the isolation width parameter, and also, another polynomial having a depending characteristic as to both a channel width and a channel length of the transistor, so that as isolation width depending parameter can be obtained in high precision.

In the circuit simulation method and circuit simulation apparatus of the present invention, the transistor corresponds to such a transistor having an activated region and an element isolating-purpose insulating film region which surrounds the activated region; the element isolating-purpose insulating film region owns a simple shape and has an activated region which is located adjacent to a position separated over a distance “Y” along the width direction of the channel only via the element isolating-purpose insulating film region from the edge of the activated region along the width direction of the channel of the transistor; and the isolation width parameter Yeff is defined based upon a formula using the distance “Y.”

In the circuit simulation method and the circuit simulation apparatus of the present invention, the transistor corresponds to such a transistor having an activated region and an element isolating-purpose insulating film region which surrounds the activated region; a useful element isolating-purpose insulating film region is defined as either an entire portion or a portion of the element isolating-purpose insulating film region; the useful element isolating-purpose insulating film region owns a geometrically complex shape; the useful element isolating-purpose insulating film region owns a distance “A” along a length direction of the channel, and can be subdivided into “n” pieces (“n” being at least one piece) of rectangular regions; each of the rectangular regions contains a width “Ai” along the length direction of the channel and an edge of each of activated regions located at a position separated from the edge of the activated region of the transistor over a distance “Yi” along the width direction of the channel; and the isolation width parameter Yeff is defined so as to be equal to 1/Σ{Ai/(AXYi)}. As a consequence, even in the element isolating-purpose insulating film region, an effective isolation width can be obtained.

In the circuit simulation method and the circuit simulation apparatus of the present invention, the transistor corresponds to such a transistor having an activated region and an element isolating-purpose insulating film region which surrounds the activated region; the element isolating-purpose insulating film region owns a geometrically complex shape; the transistor owns a point present on an edge of an activated region which is located adjacent from a point on the channel of the transistor over a distance “Yi”; the transistor owns an angle “θi” between the width direction of the channel and a straight line present between the point on the channel and a point present on the adjacent activated region; such a value obtained by integrating each of points on the adjacent activated region is defined as “m”; and the isolation width parameter Yeff is defined so as to be equal to m/Σ{cos θi/Yi}. As a consequence, even in the element isolating-purpose insulating film region having the complex shape, while only the component of the width direction of the channel is considered with respect to the element isolating-purpose insulating film width depending characteristic along the oblique direction, an effective isolation width parameter can be obtained in higher precision.

In accordance with the present invention, based upon the transistor model, the approximate expression of the parameter having the element isolating-purpose insulating film width depending characteristic is formed, and the value of the corrected parameter obtained by employing the formed approximate expression is replaced by the value of the original parameter, so that the transistor model of such a transistor is formed in which the element isolating-purpose insulating film widths are different from each other. As a result, such a transistor model which can be fitted to the drain current characteristic of the desirable isolation width can be easily formed. As a consequence, the circuit simulation can be carried out while considering the depending characteristic of the element isolating-purpose insulating film which constitutes the index of the stress, and thus, the simulation precision can be improved.

### BRIEF DESCRIPTION OF THE DRAWINGS

FIG. 1 is a block diagram for indicating an arrangement of a circuit simulation apparatus according to an embodiment mode 1 of the present invention.

FIG. 2 is a flow chart for describing a modeling method according to an embodiment mode 2 of the present invention.

FIG. 3(a) to FIG. 3(c) are plan views for indicating an example as to transistors in which sizes of element isolation-purpose insulating film widths are different from each other.

FIG. 4(a) is a plan view for representing an example of a transistor in which two element isolating-purpose insulating films are different from each other; FIG. 4(b) is a plan view for representing an example of a transistor in which two element isolating-purpose insulating films are identical to each other; and both FIG. 4(a) and FIG. 4(b) are diagrams for explaining that these transistors are equivalent to each other in view of modeling aspect.

FIG. 5 is a graphic representation in which measured values as to a depending characteristic of drain currents of a transistor with respect to an element isolating-purpose insulating film width are compared with results obtained by executing simulation in accordance with the modeling method according to the present invention.

FIG. 6 is a plan view for showing an example of a transistor according to the embodiment mode 2 of the present invention; FIG. 6(a) is a plan view for schematically showing a conduction of a parameter indicative of a stress in such a case that a shape of an adjoining activated region is irregular; FIG. 6(b) is a plan view for showing such a case that a shape of an adjoining activated region is regular; and FIG. 6(a) and FIG. 6(b) are diagrams for explaining that these transistors are equivalent to each other in view of modeling aspect.

FIG. 7 is a plan view for showing an example of a transistor according to an embodiment mode 3 of the present invention; namely, is a plan view for schematically showing a conduction of a parameter indicative of a stress in such a case that a shape of an adjoining activated region is irregular.

FIG. 8 is the plan view for indicating the example of the transistor formed in accordance with the conventional modeling method.

FIG. 9 is the block diagram for indicating the arrangement of the conventional circuit simulation apparatus.

FIG. 10 is the graphic representation in which the measured values as to the depending characteristic of the drain currents of the transistor with respect to the element isolation-purpose insulating film width are compared with the results obtained by executing the simulation in accordance with the conventional modeling method.

### DESCRIPTION OF THE PREFERRED EMBODIMENTS

Referring now to drawings, various embodiment modes of the present invention will be described.

### Embodiment Mode 1

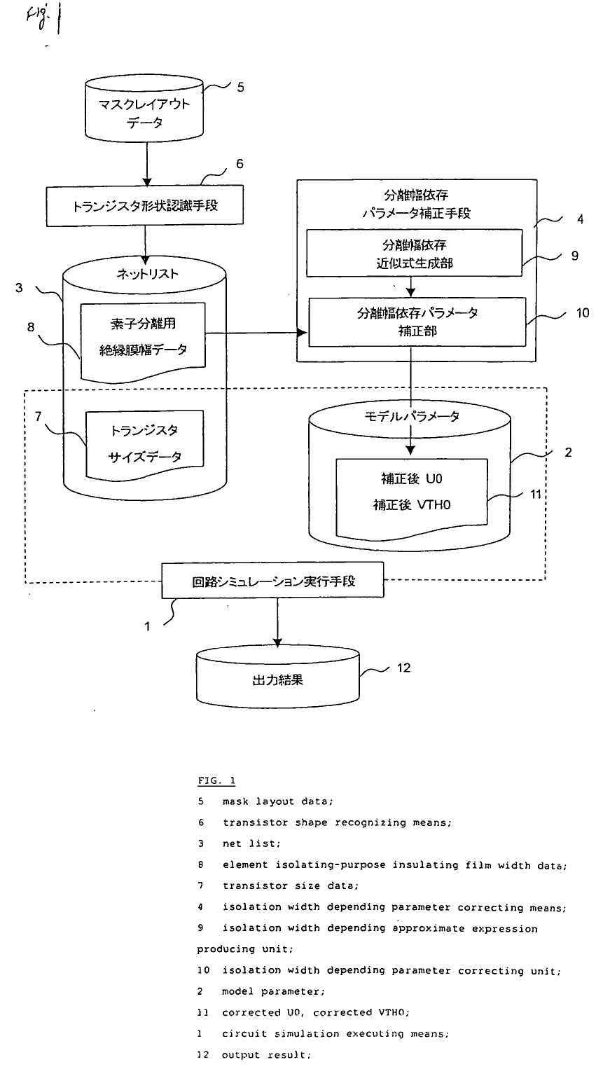

FIG. 1 is a block diagram for indicating an arrangement of a circuit simulation apparatus according to an embodiment mode 1 of the present invention.

A circuit simulation executing means 1 corresponds to a main body of a circuit simulator is typically known as SPICE (Software Process Improvement and Capability dEtermination) similar to the prior art, and corresponds to a circuit simulation executing program operated on a computer. A net list 3 and a model parameter 2 are entered to the circuit simulation executing means 1 so as to calculate an electric characteristic of a circuit which should be simulated, which is similar to that of the prior art. The net list 3 has been extracted from mask layout data of the circuit which should be simulated. The model parameter 2 has been extracted from an actually measured value of a device characteristic. However, this circuit simulation apparatus owns such a novel point that an isolation width depending parameter correcting means 4 is employed.

Transistor size data 7 such as a channel length and a channel width of a transistor is extracted by a transistor shape recognizing means 6 from mask layout data 5 having design information as to the circuit to be simulated. Also, element isolating-purpose insulating film width data 8 of a transistor is also extracted by the transistor shape recognizing means 6, and then, is stored in the net list 3. It should be understood that the element isolating-purpose insulating film width data 8 is not always stored in the net list 3.

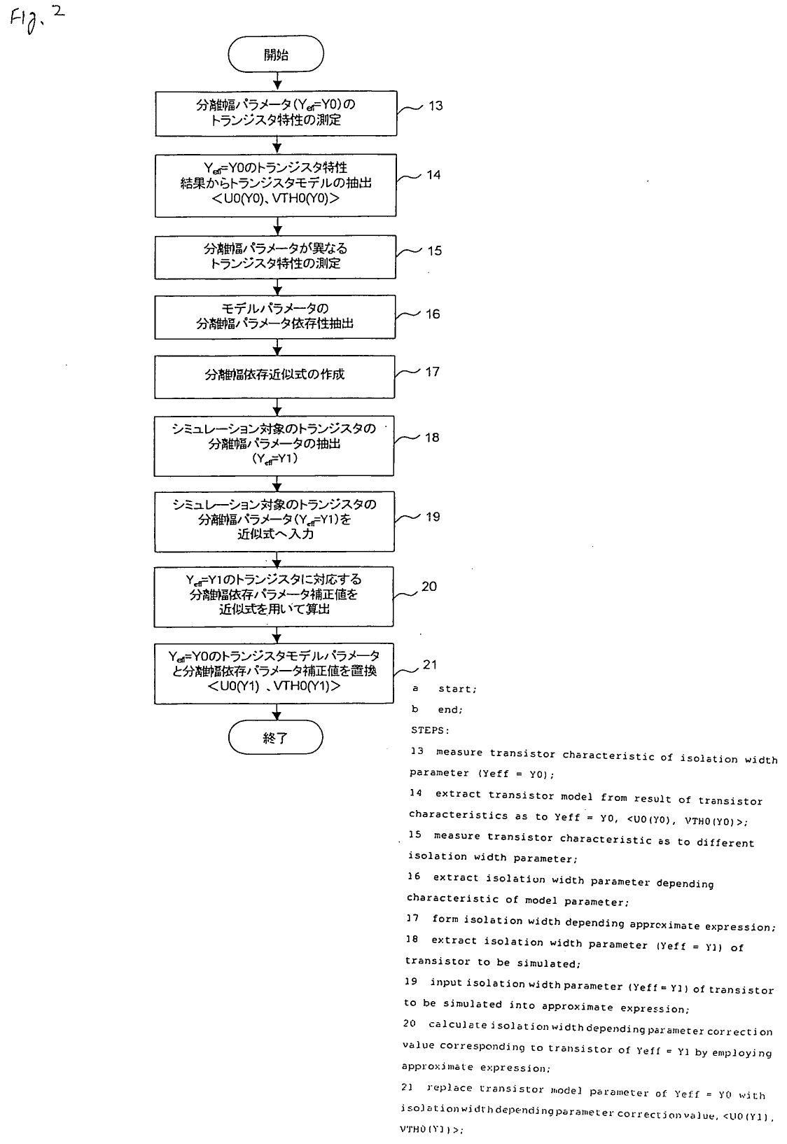

The isolation width depending parameter correcting means 4 is arranged by an isolation width depending approximate expression producing unit 9 and an isolation width depending parameter correcting unit 10. The isolation width depending approximate expression producing unit 9 produces a correcting approximate expression of a transistor model parameter whose value is changed based upon an isolation width parameter. While the above-explained correcting approximate expression corresponds to a continuous approximate expression, a content of this correcting approximate expression will be explained in detail in steps 16 and 17 of a flow chart for explaining a modeling method of FIG. 2. The isolation width parameter corresponds to a parameter which constitutes an index of a stress, and corresponds to a geometrical parameter.

In the circuit simulation apparatus of the embodiment mode 1, a transistor model parameter whose value is changed by an isolation width parameter contains a mobility parameter “U0” and a threshold value voltage parameter “VTH0.” In this embodiment mode 1, a mobility parameter and a threshold voltage parameter corresponds to “U0” and “VTH0” respectively, in models of BSIM3 and BSIM4, which are well known as an SPICE-purpose transistor model. The above-described “BSIM” corresponds to a world-wide standard model of an MOSFET. This world-wide standard model has been developed in U. C. Barkeley (California University) and has been specified in circuit simulation as a model as a current source and a capacitor in an MOSFET. In such a BSIM 4 which has be presently used in the most cases, the above-described BSIM 4 corresponds to a circuit simulation with employment of a model designed for a further very fine transistor (gate length is shorter than 0.13 μm).

The reason why a mobility parameter is selected as one of transistor model parameters whose values are changed based upon an isolation width parameter is given as follows: That is, in a transistor where an activated region is surrounded by an element isolating-purpose insulating film, carrier mobility is changed in accordance with a shape of the element isolating-purpose insulating film. In the transistor surrounded by the element isolating-purpose insulating film, a stress is applied from the element isolating-purpose insulating film to the activated region due to a difference in thermal expansion coefficients generated when a thermal processing step is carried out, so that the stress distorts crystal. The stress generated due to this difference in the thermal expansion coefficients is changed in response to the width of the element isolating-purpose insulating film, and the carried mobility is changed in connection with this stress changed, so that a drain current of the transistor is changed. Also, since a change in threshold voltages occurs in connection with the change in the carrier mobility, a threshold value parameter has been selected as such a model parameter which depends upon the isolation width parameter. Also, similarly, a saturation speed parameter (VSAT) and a source-to-drain parasitic resistance parameter (RDSW) per a unit width may correspond to the model parameter which depends upon the isolation width parameter.

In the isolation width parameter correcting unit 10, a transistor model parameter correcting value 11 of a desirable isolation width parameter is calculated by employing the formed approximate expression and the element isolating-purpose insulating film width data 8, and the calculated transistor model parameter value 11 is replaced by the original transistor model parameter. A description as to a concrete calculation will be made in steps 18 to 21 in the modeling method flow operations shown in FIG. 2.

The model parameter 3 which has been formed by the isolation width depending parameter correcting means 4 in the desirable isolation width parameter is inputted to the circuit simulation means 1, and thus, such a circuit operation is simulated by considering a depending characteristic of an isolation width parameter which constitutes an index of a stress.

FIG. 2 is a flow chart for explaining a modeling method which is executed in the isolation width depending parameter correcting means 4. This flow chart contains a step 13 through a step 21. Referring now to FIG. 2, a description is made of the modeling method according to the embodiment mode 1.

Normally, respective parameters of a transistor are extracted from transistor characteristic data acquired by changing respective terminal biases of transistors having various channel lengths “L” and various channel width sizes “W” by employing an apparatus and a means, which are not shown in FIG. 1. In FIG. 2, in a step 13, while a reference value of an isolation width parameter “Yeff” is defined as an index of a stress, an electric characteristic of the transistor when the isolation width parameter Yeff=Y0 is measured. In a next step 14, a transistor model is formed which is made coincident with the electric characteristic of the transistor when the isolation width parameter Yeff=y0. In this embodiment mode 1, it is so assumed that a mobility parameter and a threshold value parameter of the transistor when the isolation width parameter Yeff=Y0 corresponds to, for example, “U0(Y0)” and “VTH0(Y0)”, respectively.

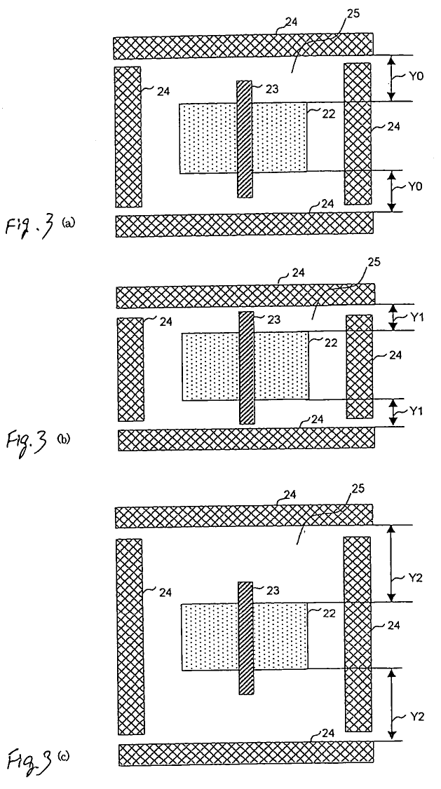

Next, in a step 15, electric characteristics of transistors whose isolation width parameters are different from each other are measured as indicated in FIG. 3(a) to FIG. 3(c).

FIG. 3(a) to FIG. 3(c) are plan views for indicating an example as to such transistors that sizes of element isolating-purpose insulating film widths are different from each other, according to the embodiment mode 1. It should also be understood that the transistors shown in these drawings own the same shapes of activated regions 22 and gate electrodes 23, and the same lengths of these activated regions 22. In FIG. 3(a) to FIG. 3(c), element isolating-purpose insulating film regions 25 have been formed in such a manner that these insulating film regions 25 surround outer sides of the activated regions 22, and activated regions 24 adjoined to each other via the element isolating-purpose insulating film regions 25 have been formed. A width of an element isolating-purpose insulating film is expressed by a distance between an edge of an activated region 22 along a width direction of a channel and another activated region 24 adjacent to the first-mentioned activated region 22. FIG. 3(a) to FIG. 3(c) indicates such a case that the element isolating-purpose insulating film areas 25 own the simple shapes, the widths of the element isolating-purpose insulating films 25 located on both sides of the activated region 22 are made equal to each other, and isolation width parameters indicated by the element isolating-purpose insulating film width correspond to “Y0”, “Y1”, and “Y2” respectively. FIG. 3(a) is a plan view for indicating such a transistor having the reference isolation width parameter Yeff=Y0 explained in the steps 13 and 14. The value as to the reference isolation width parameter Y0 corresponds to an arbitrary element isolating-purpose insulating film width whose level does not cause any problem in a circuit design. FIG. 3(b) is a plan view for representing a transistor having an isolation width parameter Yeff=Y1 which is smaller than the isolation width parameter Yeff=Y0. FIG. 3(c) is a plan view for representing a transistor having an isolation width parameter Yeff=Y2 which is larger than the isolation width parameter Yeff=Y0.

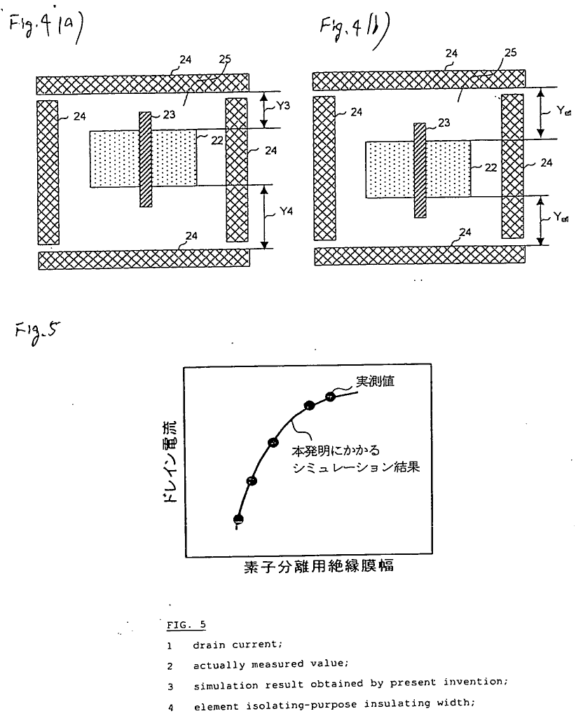

FIG. 4(a) is a plan view for indicating an example of such a transistor that widths of element isolating-purpose insulating films are different from each other which are located on both sides of an activated region 22. A first geometrical parameter Y3 indicates a first distance between an edge of the activated region 22 along a width direction of a channel and the activated region 24 adjacent to the first-mentioned activated region 22. A second geometrical parameter Y4 indicates a second distance of an element isolating-purpose insulating film along a width direction of a channel different from the first geometrical parameter Y3. This isolation width parameter “Yeff” is defined by the following formula (1):

[Formula 1]
Y_{eff}=(1/Y3+1/Y4)/2 formula (1).

In view of a modeling operation, it can be regarded that the transistor of FIG. 4(a) is equivalent to a transistor of FIG. 4(b) in such a case that two element isolating-purpose insulating film widths are equal to each other.

In a step 16 of FIG. 2, an isolation width parameter depending characteristic of the mobility parameter U0 and an isolation width parameter depending characteristic are extracted from the transistor electric characteristics such as the drain current and the threshold value voltage measured in the step 15, and then, in a step 17, an approximate expression is formed from a relationship between the isolation width parameter characteristics of the respective parameters. The formed approximate expression is constituted by containing a term which is directly proportional to inverse numbers of the isolation width parameters. Also, since the isolation width parameter depending characteristic of the mobility parameter U0 and the isolation width parameter depending characteristic of the threshold value voltage parameter VHT0 are different from each other depending upon the channel length “L” and the channel width “W” of the transistor, terms of the depending characteristics as to the channel length “L” and the channel width “W” are extracted from the isolation width parameter depending characteristics in the various sizes of the transistors extracted in the step 16. Since a current characteristic variation of a transistor owns a phenomenon that in connection with narrowing of the isolation width the current characteristic variation becomes conspicuous (namely, a relationship approximated to inverse relationship of isolation width), it is possible to represent such a characteristic which is approximated closer to the phenomenon by involving the term of the inverse number. In particular, the approximate expression may become effective with respect to simulation as to transistors of a condensed layout.

In the embodiment mode 1, there is such an example as to correcting approximate formulae of transistor model parameters whose values are changed in response to isolation width parameters as follows:

[Formula 2]
U0(Y_{X})=U0(Y0)X formula (2).
[Formula 3]
VTH0(Y_{X})=VTH0(Y0)+ formula (3).

In this example, symbols “U0 (Y0)” and “VTH0 (Y0)” indicate both the mobility parameter value and the threshold voltage parameter value when the isolation width parameter formed in the step 14 is equal to “Y0.” Symbols “U0(YX)” and “VTH0(YX)” show both a mobility parameter and a threshold value parameter, which are determined as to a desirable isolation width parameter Yeff=YX. Symbol “αWL” represents a coefficient which depends upon the channel length “L” and the channel width “W” of the transistor.

Next, in a step 18 of FIG. 2, element isolating-purpose insulating film width data 8 of the transistor is measured from the mask layout data 5 of the circuit to be simulated, and then, a desirable isolation width parameter Yeff=Y1 is obtained which constitutes an index of a stress. Next, in a step 19, the isolation width parameter Y1 extracted in the step 18 is substituted for the approximate expressions (formula (2) and formula (3)) formed in the step 17, and in a next step 20, both an isolation width depending parameter U0(Y1) and another isolation width depending parameter VTH0 (Y1) corresponding to the transistor having the desirable isolation width parameter Yeff=Y1 are calculated.

In a step 21, the model parameters U0(Y0) and VTH0 (Y0) of the transistor which owns the original isolation width parameter Yeff=Y0 are replaced by the isolation depending parameters U0(Y1) and VTH0(Y1) calculated in the step 20, so that such a circuit simulation can be realized by considering the depending characteristics of the isolation width parameters which constitute the index of the stress.

FIG. 5 is a graphic representation for representing one comparison example in which the measured values of the depending characteristics with respect to the isolation width parameter Yeff of the drain current of the P-channel transistor are compared with results (sold line) obtained by performing the circuit simulation by employing the transistor model to which the present invention has been applied and has been substituted to the corrected values of the respective isolation width depending parameters. Different from the discrete model of the prior art shown in FIG. 10, the isolation width parameter depending characteristic is reflected to both the mobility parameter U0 and the threshold value parameter VTH0 by employing the continuous approximate expression. As a result, the isolation width parameter depending characteristic of the drain current can be expressed in very good conditions. It should also be understood that the above-described simulation method of the embodiment mode 1 may be similarly applied to an N-channel transistor.

### Embodiment Mode 2

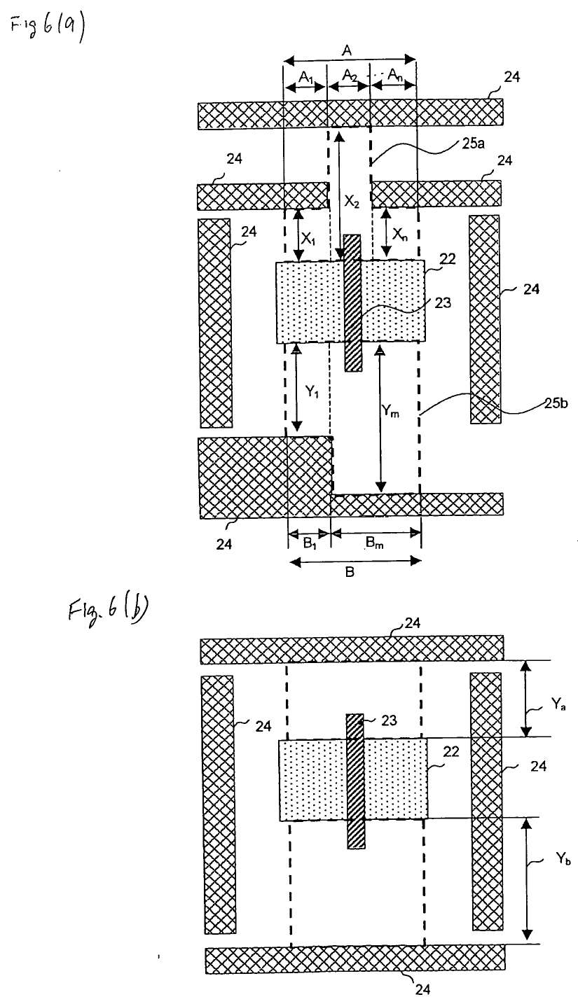

FIG. 6(a) is a plan view for indicating an example of a transistor according to an embodiment mode 2 of the present invention. It should be understood that the same reference numerals shown in the embodiment mode 1 will be employed as those for denoting the same, or similar structural elements of the embodiment mode 2. A different point between the modeling method of this embodiment mode 2 and the embodiment mode 1 is given as follows: That is, as indicated in FIG. 6(a), a modeling method can be carried out in such a case that shapes of activated regions 24 adjacent to each other along a width direction of a channel of the transistor are irregular.

In FIG. 6(a), regions of element isolating-purpose insulating films where an influence of a stress given to the channel of the transistor is expected to be especially strong are defined as a useful element isolating-purpose insulating film region 25a and another useful element isolating-purpose insulating film region 25b. These useful element isolating-purpose insulating film regions 25a and 25b are subdivided into “n” pieces of regions and “m” pieces of regions respectively. The respective subdivided regions own widths “Ai” and “Bi” along the length direction of the channel, and also, edges of a region, which are separated by a distance Xi and another distance Yi from edges of the activated region 22 of the transistor along the width direction of the channel, namely, adjoining edges of the activated region 24. Each summation as to the widths “Ai” and the widths “Bi” of the divided regions are defined as a distance “A” and another distance “B.” As this distance, such a value may be desirably employed which is obtained by adding a gate length to a minimum distance between the gate and the edge of the activated region along the length direction of the channel.

In this case, isolation width parameters which constitute an index of a stress and are determined based upon the useful element isolating-purpose insulating film regions 25a and 25b are assumed as “Ya”, and “Yb” respectively. Then, these isolation width parameters “Ya” and “Yb” are defined by the below-mentioned formulae:
Formula 4]

$$\begin{matrix} Ya = 1 / {\sum }_{i = 1}^{n} \{ Ai / A * Xi \} . & formula ( 4 ) \\ Yb = 1 / {\sum }_{i = 1}^{m} \{ Bi / B * Yi \} . & formula ( 5 )\end{matrix}$$

Formula 5]

In view of modeling operation, an averaged distance of the useful element isolating-purpose insulating film width region 25a along the width direction of the channel becomes “Ya”, which have been weighted by the widths A1, A2, - - - , An of the divided regions, and similarly, an averaged distance of the useful element isolating-purpose insulating film width region 25b along the width direction of the channel becomes “Yb”, which have been weighted by the widths A1, A2, - - - , An of the divided regions. As a result, it is possible to regard that the transistor shown in FIG. 6(a) is similar to a transistor indicated in FIG. 6(b). The transistor of FIG. 6(b) may be regarded to be similar to the transistor of the embodiment mode 1, in which the two element isolating-purpose insulating film widths are different from each other. As a consequence, an isolation width parameter Yeff is defined by the below-mentioned formula:

[Formula 6]
Yeff=(1/Ya+1/Yb)/2 formula (6).

Both the circuit simulation apparatus and the modeling method, according to the embodiment mode 2, are identical to those of the above-explaiend embodiment mode 1 except for the modeling method of the isolation width parameter “Yeff”, and can realize such a circuit simulation in higher precision by considering the depending characteristic of the isolation width parameter which constitutes the index of the stress even in such a case that the adjoining activated regions have the irregular shapes.

### Embodiment Mode 3

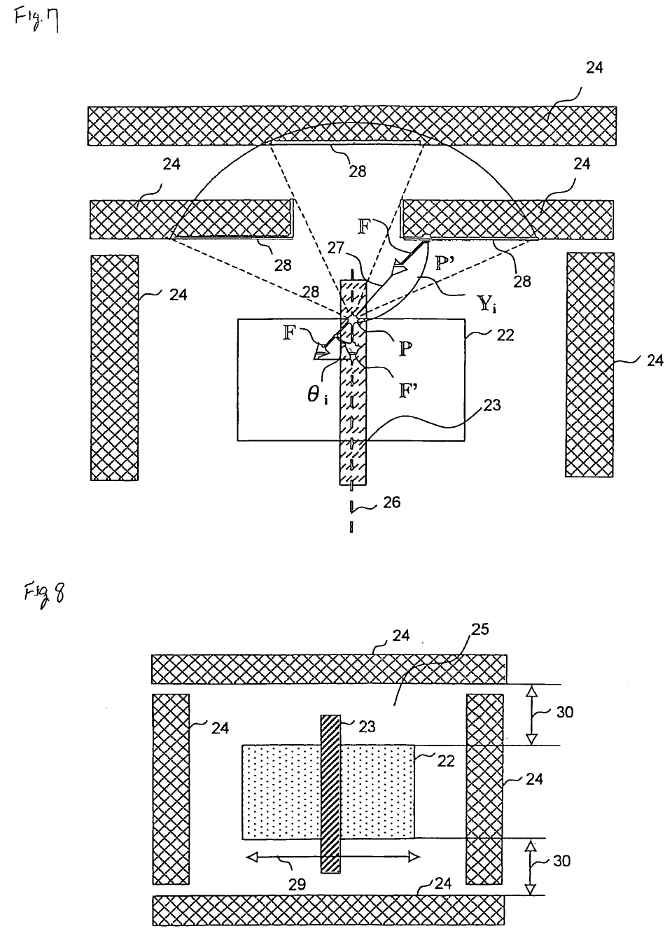

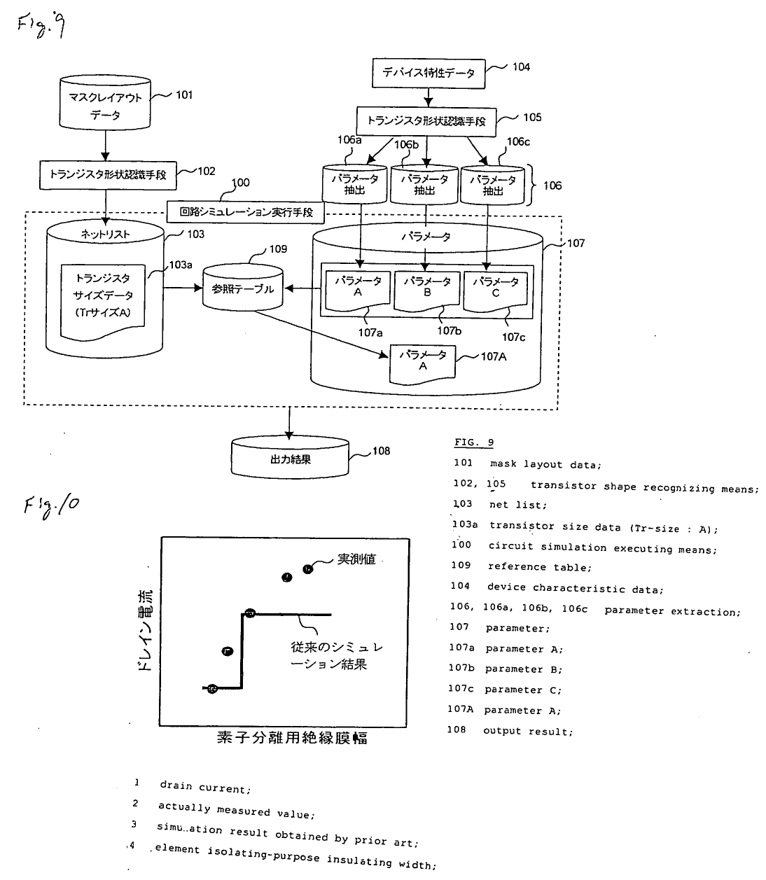

FIG. 7 is a plan view for indicating an example of a transistor according to an embodiment mode 3 of the present invention. It should be understood that the same reference numerals shown in the embodiment mode 1 will be employed as those for denoting the same, or similar structural elements of the embodiment mode 3. A different point between the modeling method of this embodiment mode 3 and the embodiment mode 1 is given as follows: That is, as indicated in FIG. 7, a modeling method can be carried out in such a case that shapes of activated regions 24 adjacent to each other along a width direction of a channel of the transistor are irregular.

As shown in FIG. 7, a straight line 27 is defined, while this straight line 27 is originated from a cross point “P” between an activated region 22 of a transistor and a center line 26 of a gate thereof up to a point “P′” of an edge of another activated region 24 which is located adjacent to the first-mentioned activated region 22 along a width direction of a channel. It is desirable that the straight line 27 does not penetrate through the activated region 24 located adjacent to the activated region 22, and a length of the straight line 27 is shorter than a predetermined boundary distance. It is also desirable that the predetermined boundary distance becomes sufficiently large to a certain extent that an element isolating-purpose insulating film width may give a substantially adverse influence to a transistor characteristics, and thus is preferably longer than, or equal to approximately 2 μm. Also, according to the example of FIG. 7, a portion which may be taken by the point P′ of the edge of the adjoining activated region 24 is present on a wide line 28 shown in this drawing.

Also, assuming now that a distance between the cross point “P” and the cross point “P′” between the straight line 27 and the adjoining activated region 24 is defined as “Yi”; an angle between the straight line 27 and a line along the width direction of the channel is defined as “θi”; and such a component which expresses a stress applied from the cross point “P′” to the cross point “P” is defined as “F”, it is conceivable that a stress “F′” which is applied to the cross point “P” along the width direction of the channel of the transistor is equal to Fxcosθ. As apparent from the foregoing explanation, an isolation width parameter “Ya” which constitutes an index of a stress is defined by the following formula:
[Formula ∂]

$$Ya = m / {\sum }_{i = 1}^{n} \{ cos θ ii / Yi \} . \qquad formula ( 7 )$$

In this formula, symbol “m” corresponds to an integrated value of the cross point P′, namely a total distance of the wide line 28. Based upon the above-described formula (7), such an effective isolation width parameter “Ya” can be obtained in higher precision by considering only the component along the width direction of the channel with respect to the depending characteristic of the element isolating-purpose insulating film width from the adjoining activated region 24 which is present from the channel of the transistor along an oblique direction.

Similarly, another isolation width parameter “Yb” related to an element isolating-purpose insulating film along a width direction of another channel is defined based upon such a formula similar to the above-described formula (7). As a result, the transistor of FIG. 7 may be regarded to be similar to the transistor of the embodiment mode 1, in which the two element isolating-purpose insulating film widths are different from each other, so that an isolation width parameter “Yeff” is defined by the below-mentioned formula:

[Formula 8]
Yeff=(1/Ya+1/Yb)/2 formula (8).

Both the circuit simulation apparatus and the modeling method, according to the embodiment mode 3, are identical to those of the above-explained embodiment mode 1 except for the modeling method of the isolation width parameter “Yeff”, and can realize such a circuit simulation in higher precision by considering the depending characteristic of the isolation width parameter which constitutes the index of the stress even in such a case that the adjoining activated regions have the irregular shapes.

Although the shape depending characteristics of the element isolating-purpose insulating films have been described in the above-explained embodiment modes of the present invention, the present invention is not limited only to the element isolating-purpose insulating films, but may be applied to various sorts of simulation by employing such a manner that since continuous mathematical models are used based upon size data as to functional portions such as gate widths by considering depending characteristics of parameters such as switching characteristics, transistor models are formed in high precision with respect to size data over a wide range.

While the circuit simulation apparatus according to the present invention owns the modeling method which expresses the shape depending characteristic such as the element isolating-purpose insulating film, the circuit simulation apparatus can realize the circuit simulation in high precision in designing of the integrated circuits in very fine modes.

What is calimed is:

1. A circuit simulation method for modeling an integrated circuit which contains at least one transistor, comprising the steps of:
acquiring size data as to an element isolating-purpose insulating film width of the transistor contained in the integrated circuit;
defining an isolation width parameter “Yeff” expressed by a formula of the element isolating-purpose insulating film width, and for forming an approximate expression as to an isolation width depending parameter whose value is changed, depending upon the isolation width parameter with respect to a transistor model formed based upon a transistor having a predetermined isolation width parameter;
calculating a correction value of the isolation width depending parameter as to a transistor model whose isolation width parameter is different from that of the transistor model based upon the approximate expression;
replacing a transistor model formed based upon the transistor having the predetermined isolation width parameter by a transistor model formed based upon the isolation width depending parameter corrected by the approximate expression; and
executing circuit simulation by employing the transistor model based upon the corrected isolation width depending parameter, while considering an element isolating-purpose insulating film width depending characteristic.

2. The circuit simulation method according to claim 1 wherein:
the approximate expression forming step includes the steps of:
acquiring device characteristic data of a transistor of various isolation width parameters; and
extracting an isolation width parameter depending characteristic of a model parameter from the acquired device characteristic data.

3. The circuit simulation method according to claim 1 wherein:
the isolation width depending parameter contains either a carrier mobility parameter or a threshold voltage parameter.

4. The circuit simulation method according to claim 1, wherein the approximate expression as to the isolation width depending parameter contains a polynomial of an inverse number of the isolation width parameter.

5. The circuit simulation method according to claim 1, wherein the isolation width depending parameter owns a depending characteristic as to both a channel width and a channel length of the transistor.

6. The circuit simulation method as claimed in claim 1, wherein:
the transistor corresponds to such a transistor having an activated region and an element isolating-purpose insulating film region which surrounds the activated region, and also, owns another activated region located at a position adjacent from the activated region of the transistor by a distance “Y” along a width direction of the channel; and the isolation width parameter Yeff is defined based upon a formula using the distance “Y.”

7. The circuit simulation method as claimed in claim 1, wherein:
the transistor corresponds to such a transistor having an activated region and an element isolating-purpose insulating film region which surrounds the activated region; a useful element isolating-purpose insulating film region is defined as a portion of the element isolating-purpose insulating film region; the useful element isolating-purpose insulating film region owns a distance “A” along a length direction of the channel, and can be subdivided into “n” pieces (“n” being at least one piece) of rectangular regions; each of the rectangular regions contains a width “Ai” along the length direction of the channel and an edge of each of activated regions located at a position separated from the edge of the activated region of the transistor over a distance “Yi” along the width direction of the channel; and the isolation width parameter Yeff is defined so as to be equal to 1/Σ{Ai/(A×Yi)}.

8. The circuit simulation method as claimed in claim 1 wherein:
the transistor corresponds to such a transistor having an activated region and an element isolating-purpose insulating film region which surrounds the activated region; the transistor owns a point present on an edge of an activated region which is located adjacent from a point on the channel of the transistor over a distance “Yi”; the transistor owns an angle “θi” between the width direction of the channel and a straight line present between the point on the channel and a point present on the adjacent activated region; such a value obtained by integrating each of points on the adjacent activated region is defined as “m”; and the isolation width parameter Yeff is defined so as to be equal to m/Σ{cos θi/Yi}.

9. A circuit simulation apparatus comprising:
means for acquiring a shape of a transistor and size data of an element isolating-purpose insulating film width contained in an integrated circuit from layout data of the integrated circuit;
means for defining an isolation width parameter “Yeff” expressed by a formula of the element isolating-purpose insulating film width, and for forming an approximate expression as to an isolation width depending parameter whose value is changed, depending upon the isolation width parameter with respect to a transistor model formed based upon a transistor having a predetermined isolation width parameter;
means for calculating a correcting value of an isolation width depending parameter as to a transistor model whose isolation width parameter is different from that of the transistor model based upon the approximate expression;
means for replacing a transistor model formed based upon the transistor having the predetermined isolation width parameter by a transistor model formed based upon the isolation width depending parameter corrected by the approximate expression; and
simulation executing means for reading a circuit connection description of the integrated circuit, for inputting a transistor model based upon the corrected isolation width depending parameter, and for calculating a characteristic of the transistor in which the element isolating-purpose insulating films are different from each other, while considering an element isolating-purpose insulating film depending characteristic.

10. The circuit simulation apparatus, as claimed in claim 9 wherein:
the isolation width depending parameter contains either a carrier mobility parameter or a threshold voltage parameter.

11. The circuit simulation apparatus as claimed in claim 9, or claim 10 wherein:
the approximate expression as to the isolation width depending parameter is constituted by containing a polynomial of an inverse number of the isolation width parameter.

12. The circuit simulation apparatus as claimed in any one of claim 9 to claim 11 wherein:
the isolation width depending parameter owns a depending characteristic as to both a channel width and a channel length of the transistor.

13. The circuit simulation apparatus as claimed in claim 9, wherein:
the transistor corresponds to such a transistor having an activated region and an element isolating-purpose insulating film region which surrounds the activated region, and also, owns another activated region located at a position by a distance “Y” along a width direction of the channel from an edge of the activated region of the transistor along the width direction of the channel; and the isolation width parameter “Yeff” is defined based upon a formula using the distance “Y.”

14. The circuit simulation apparatus as claimed in claim 9 wherein:
the transistor corresponds to such a transistor having an activated region and an element isolating-purpose insulating film region which surrounds the activated region; a useful element isolating-purpose insulating film region is defined as a portion of the element isolating-purpose insulating film region; the useful element isolating-purpose insulating film region owns a distance “A” along a length direction of the channel, and can be subdivided into “n” pieces (“n” being at least one piece) of rectangular regions; each of the rectangular regions contains a width “Ai” along the length direction of the channel and an edge of each of activated regions located at a position separated from the edge of the activated region of the transistor over a distance “Yi” along the width direction of the channel; and the isolation width parameter Yeff is defined so as to be equal to 1/ZΣ{Ai/(A×Yi)}.

15. A circuit simulation apparatus as claimed in claim 9, wherein:
the transistor corresponds to such a transistor having an activated region and an element isolating-purpose insulating film region which surrounds the activated region; the transistor owns a point present on an edge of an activated region which is located adjacent from a point on the channel of the transistor over a distance “Yi”; the transistor owns an angle “θi” between the width direction of the channel and a straight line present between the point on the channel and a point present on the adjacent activated region; such a value obtained by integrating each of points on the adjacent activated region is defined as “m”; and the isolation width parameter Yeff is defined so as to be equal to m/Σ{cos θi/Yi}.
